(19) United States
(12) Patent Application Publication
(10) Pub. No.: US 2006/0059987 A1
(43) Pub. Date: Mar. 23, 2006

(54) Systems and methods for sensing and/or measuring flow rate of gases based upon mass flow conditions

(75) Inventors: Andreas T. Melville, Brookfield, WI (US); Patrick M. Torok, Cincinnati, OH (US)

Correspondence Address: RYAN KROMHOLZ & MANION, S.C., POST OFFICE BOX 26618, MILWAUKEE, WI, 53226, US

(73) Assignee: Waukee Engineering Company, Inc.

(21) Appl. No.: 11/231,732

(22) Filed: Sep. 21, 2005

Related U.S. Application Data
(60) Provisional application No. 60/611,903, filed on Sep. 21, 2004.

(51) Int. Cl. G01F 1/68

(52) U.S. Cl. 73/202.5

(57) ABSTRACT

Systems and methods for, e.g., heat treating, make use of flow rate measuring based upon sensing of mass gas flow conditions.

### RELATED APPLICATIONS

This application claims the benefit of U.S. Provisional Patent Application Ser. No. 60/611,903, filed Sep. 21, 2004, titled “Systems and Methods for Sensing and/or Measuring Flow Rate of Gases Based Upon Mass Flow in Heat Treating Environments.”

### FIELD OF THE INVENTION

This invention relates generally to the measurement and/or measuring of gas atmospheres used in conjunction with heat treating apparatus.

### BACKGROUND OF THE INVENTION

In a typical heat treatment system a single gas or a mixture of gasses, comprise the heat treating atmosphere. The flow rate of these gasses are typically sensed by rotometers. The rotometer can include a visual flow indicator, which comprises a ball or float that is lifted within a tapered tube by the moving/flowing gas volume, the amount of the lift being proportional to the magnitude of the gas flow rate. A rotometer of this kind can be purchased, e.g., from Waukee Engineering Company, Inc, Milwaukee, Wis.

A rotometer needs to be calibrated for a specific gas at a known gas temperature and a known gas pressure to accurately correlate the lift distance of the ball or float within the tube to the gas flow rate. However, ambient changes in gas temperature and/or gas pressure can, or course, alter this correlation and lead to incorrect indicated readings.

Mass flow meters are used outside the heat treating field for measuring and controlling the specific amount of flow of a fluid, necessary for a particular process, e.g., in semiconductor manufacturing processes, such as chemical vapor deposition or the like. Mass flow controllers are known to be capable of sensing the flow occurring through the controller and modifying or controlling that flow as necessary to achieve the required control of the flow rate of the fluid delivered to the particular process. Mass flow controllers are not sensitive to gas temperature variations and/or gas pressure variations.

According to conventional wisdom, mass flow controllers require low volume, laminar (i.e., non-turbulent) gas flow conditions, to assure a linear relationship between monitored mass flow and actual gas flow rate. Laminar flow conditions require relatively large inlet pressures and can lead to relatively large pressure drops across the mass flow controller. On the other hand, heat treating is characterized by the existence of high volume, turbulent flow conditions. These conditions are not laminar and do not accommodate the large pressure drops required for mass flow measurements.

By way of example, in heat treating, gas flow into the heat treating furnace is typically turbulent, and at relatively low pressures, e.g., <1 psi, and occurs at relatively high flow volumes, which are measured in cubic feet per hour (CFH) with magnitudes of several hundred CFH and often much higher, e.g., 1000 to 5000 CFH. In contrast, in a semiconductor manufacturing process, laminar (non-turbulent) flow conditions and significantly lower flow rates are encountered, which are measured in cubic centimeters per minute (cc/min), with magnitudes, e.g., up to about 100 cc/min. Thus, the flow volumes typically encountered in heat treating are at least three orders of magnitude higher than those encountered in semiconductor manufacturing conditions.

Thus, processing conditions typical for heat treating inherently mitigate against the use of conventional mass flow sensing devices.

### SUMMARY OF THE INVENTION

One aspect of the invention provides systems and methods for measuring a gas flow rate—or that include a flow rate measuring assembly—which are based, at least in part, upon sensing of mass gas flow conditions.

In one embodiment, the flow rate measuring assembly shunts a relatively small volume of turbulent gas flow in a main flow path through a gas flow sampling path for mass flow measuring. The gas flow sampling path includes an in-line mass flow sensor. The low volume mass flow conditions within the sampling path mirror the turbulent flow conditions within the high volume main flow path. As a result, the raw output of the mass flow sensor in the sampling path is not linear with respect to the main gas flow rate. The flow rate measuring assembly includes a conversion function that electronically processes the raw non-linear output and converts it into a flow rate output that can be linearly related to the main flow rate with surprising accuracy.

In one arrangement, the conversion function can, e.g., include a correlation that fits the raw non-linear output of the particular mass flow sensor in use to a generalized linear construct or curve to yield a flow rate. The generalized linear construct or curve can be developed empirically to function with acceptable accuracy in association with a family or families of mass flow sensors, even though the outputs, given the same mass flow conditions, may vary somewhat among them. In this arrangement, the generalized linear conversion will also need to assume the same specific gravity or range of specific gravities conditions for the measured gas, as well as common units of measurement in which the outputs are expressed.

In another arrangement, the flow rate measuring assembly includes a compensation function. The compensation function generates a linear correlation between non-linear mass flow outputs of a given mass flow sensor in use and corresponding gas flow rates based upon actual existing gas flow conditions. The compensation function thereby develops for the conversion function a linear construct or curve that is reflects the actual gas flow conditions and the actual performance characteristic of the in-line mass flow sensor in use. Use of the compensation function eliminates loss of accuracy due to performance variations among different flow sensors, or variations in gas flow conditions, such as specific gravity for the measured gas, change or degradation of the sensor over time, or differences among units of measurement that may exist for the outputs of different types of mass flow sensors.

By physically placing the mass flow sensor in a gas flow sample path outside the main flow path, and by electronically processing the raw output of the mass flow sensor, the flow rate measuring assembly establishes a virtual laminar flow condition for the main flow, where there is a linear relationship between sensed mass flow and the actual gas flow rate.

### DESCRIPTION OF THE DRAWINGS

FIG. 1 is a diagrammatic view of a heat treating system that includes a flow rate measuring assembly that is based upon sensing of mass gas flow conditions.

FIG. 2 is a more detailed diagrammatic view of the flow rate measuring assembly shown in FIG. 1.

FIGS. 3A and 3B are diagrammatic views of the components of alternative embodiments of the flow rate measuring assembly, which shunts a portion of gas flow volume through gas flow sampling path having an in-line mass flow sensor.

FIG. 4 is a graph that plots the non-linear raw output of the mass flow sensor shown in FIG. 3 and the linearized output provided by a signal conversion function that forms a part of the flow rate measuring assembly.

FIG. 5 is a diagrammatic view of the signal conversion function that forms a part of the flow rate measuring assembly.

FIG. 6 is a graph that plots the non-linear raw output of four mass flow sensors of the same type, demonstrating the variability among sensors of the same type.

FIG. 7 is a diagrammatic view of a comparison function that, in one embodiment, forms a part of the flow rate measuring assembly.

FIG. 8 is an assembled perspective view of a representative physical embodiment of a flow rate measuring assembly as shown in the preceding figures.

FIG. 9A is an exploded, side sectional view of the representative physical embodiment of a flow rate measuring assembly as shown in FIG. 8, taken generally along line 9A/B in FIG. 8.

FIG. 9B is an assembled, side sectional view of the representative physical embodiment of a flow rate measuring assembly as shown in FIG. 8, taken generally along line 9A/B in FIG. 8, further showing a signal processor that includes the signal conversion function.

FIG. 10 is a perspective view of a representative unification of the flow rate measuring assembly shown in FIGS. 8, 9A, and 9B with a conventional rotometer, which provides the best of analog and digital worlds in a compact, convenient package.

### DETAILED DESCRIPTION

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

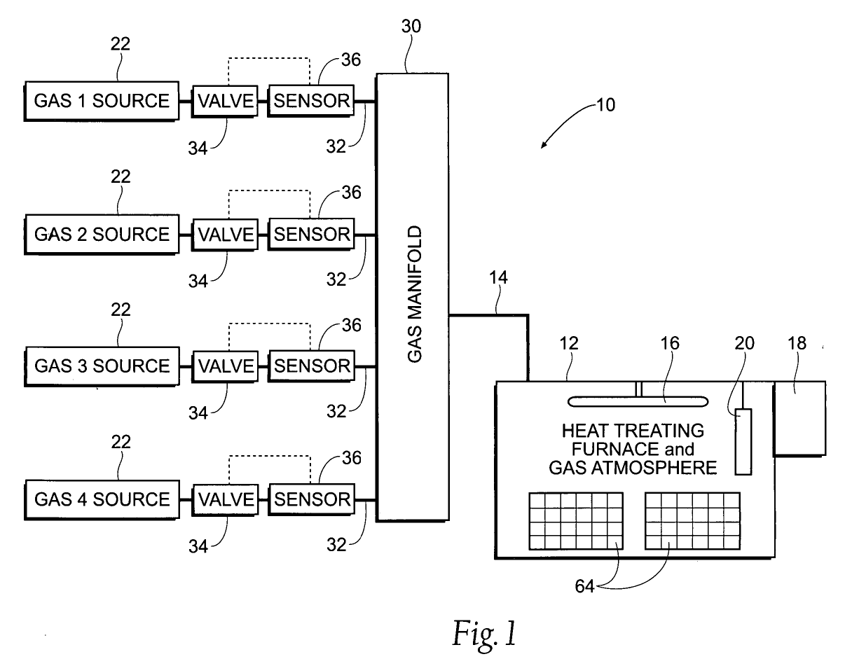

FIG. 1 shows a heat treating system 10. The system 10 includes a conventional heat treating furnace 12. The details of its construction are not material to the invention. The furnace 12 can comprise a conventional rotary retort type carburizing furnace, like that shown in Schneider U.S. Pat. No. 4,966,348. The furnace can also comprise a conventional endothermic generator. The furnace 12 can also be one of the various alternative types of furnaces shown in “ASM Handbook (Heat Treating),” Volume 4, pages 465-474, published by ASM International (1991).

A heat treating atmosphere is conveyed through a supply line 14 into the furnace 12. A mixer 16 (e.g., a fan or the like) circulates the heat treatment atmosphere within the furnace 12.

A heat source 18 heats the interior of the furnace 12, and thus the heat treating atmosphere itself. The heated atmosphere reacts with rigid loads 64, e.g., metal, placed into the furnace 12, to achieve the desired heat treatment objectives.

A conventional in situ oxygen sensor 20, in association with a thermocouple, is typically installed in the heat treating furnace 12 in direct contact with the heated gas atmosphere. The sensor 20 outputs a voltage signal which is related to the condition of the gas atmosphere within the furnace 12, such as percent oxygen, dew point, or percent carbon. Maintaining the desired oxygen content at some specific temperature within the furnace controls the heat treating atmosphere. Metal Handbook, Vol. 4, pp. 417-431 (9th Edition 1981) contains a further discussion of atmosphere control in a heat treating furnace.

The system 10 includes sources 22, 24, 26, and 28 of the various gases that, when mixed, comprise the heat treating atmosphere. The type of source gases 22, 24, 26, 28 can vary according to the heat treatment objectives. For example, one of the source gases 22 can comprise an endothermic gas. Another source gas 24 can comprise natural gas. Another source gas 26 can comprise air (oxygen). Another source gas 28 can comprise ammonia. Other types of source gases can be used, depending upon the nature and type of heat treating desired.

The measured gases 22, 24, 26, and 28 are mixed within a manifold 30 and then conveyed by the supply line 14 to the furnace 12. Each source gas 22, 24, 26, and 28 is conveyed into the manifold 30 through an individual inlet line 32. As earlier explained, due to the nature of heat treating, flow within an individual inlet line 32 is characterized by turbulence, low pressure, and relatively high flow volumes, which are measured in cubic feet per hour (CFH) with magnitudes approaching 100 CFH and typically much higher, e.g., 1000 to 5000 CFH.

To control the relative high flow rates of gases 22, 24, 26, and 28 into the manifold 30, and thus the composition of the atmosphere itself, each individual inlet line 32 includes a control valve 34. The control valve 34 can be manually adjusted by an operator, or it can be electrically controlled from a remote control station.

To measure the flow rate, each inlet line 32 includes its own flow rate measuring assembly 36. The flow rate measuring assembly 36 senses the rate of gas flow through the line 32 and may provide an output related to the magnitude of the flow rate.

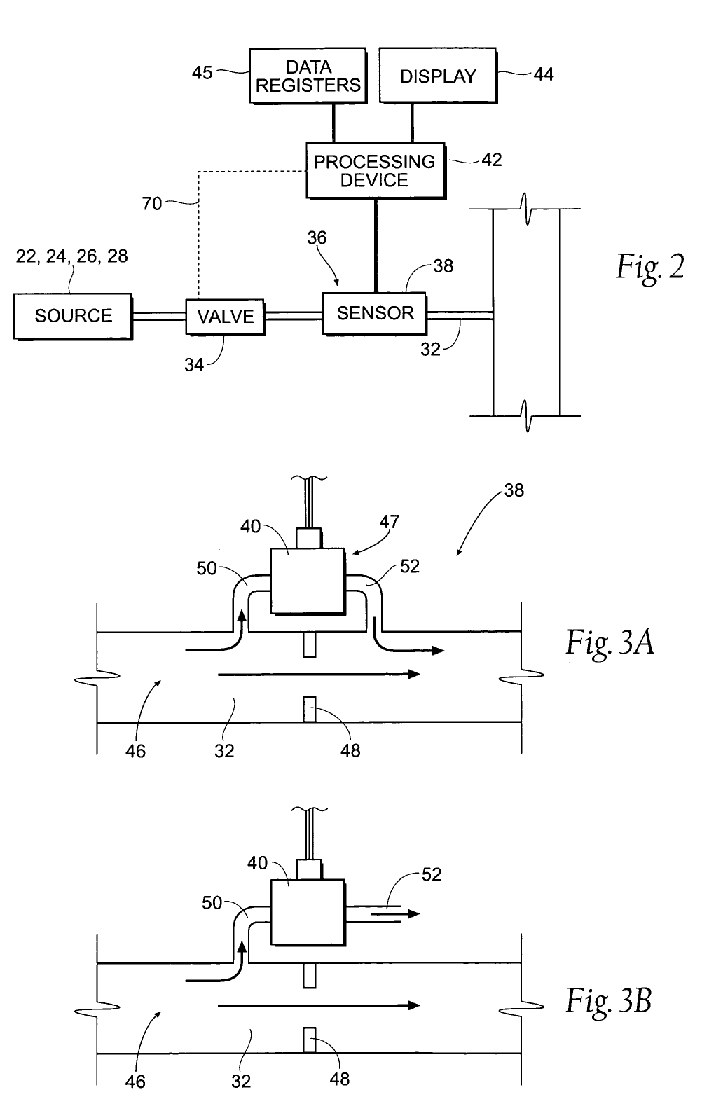

In the illustrated embodiment, at least one of the flow rate measuring assemblies 36 includes a mass flow sensor 38 (see FIG. 2). Various types of mass flow sensors 38 can be used. Such mass flow sensors 38 have been used outside the heat treating field, e.g., in semiconductor manufacturing processes, such as chemical vapor deposition or the like. One typical example of a conventional mass flow sensor 38 comprises a resistance temperature device. The resistance temperature device measures the temperature differential between upstream and downstream heater/sensor coils exposed to the fluid flow. A voltage is generated that is proportional to the mass of gas flow through the device. Other conventional mass flow sensors may use absolute and/or differential pressure changes, light absorption, or the momentum change (e.g., paddle wheel) to measure the mass flow.

The flow rate measuring assembly 36 includes a signal processing device or microprocessor 42, which is coupled to the outlet of the mass flow sensor 38. The signal processing device 42 includes a conversion function that applies preprogrammed logic or an algorithm, to convert the output of the mass sensor 38 to a gas flow rate in the supply line 32.

The microprocessor 42 can include or otherwise be coupled to a display device 44, which visually displays the flow rate and other meaningful derived information, as well as to data registers 45, which collect and organize the data for off-line storage and/or printing for record keeping purposes. The microprocessor 42 can also be coupled by a feedback loop 70 to the control valve 34, to automatically maintain an actual flow rate according to a predetermined set point, and thereby provide automated control of gas delivery.

In one illustrated embodiment (see FIG. 3A), mass flow sensor 38 comprises a resistance temperature device 40, as earlier described. To adapt the resistance temperature device 40 for accurate and reliable operation in the turbulent, high volume gas flow conditions typically present in the main line 32, the flow rate measuring assembly 36 places the resistance temperature device 40 outside the large volume flow path 46 of gas in the gas inlet line 32 and in a low volume sample measuring path 47. In a representative embodiment, the ratio between the volume of the large volume main flow path 46 and the volume of the low volume sample measuring path 47 is at least 100:1. For example, given a main flow path 46 having an area of about 0.4 in², the low volume sampling path 47 has a much smaller area of 0.003 in². The sample measuring path 47 presents only a small volume of the gas within the main flow path 46 for sampling by the mass flow sensor 40.

To promote flow out of the main path 46 into the sample measuring path 47, the mass flow sensor 38 can also include a restricting orifice 48, which is positioned in the main path 46 of gas flow within inlet line 32 in juxtaposition with the sample measuring path 47. The orifice 48 creates a pressure differential between the inlet and outlet ends of the sample measuring path 47, which is believed to be helpful, particularly when the flow rates are low, e.g., about 100 CFH and below. At higher flow rate conditions within the main path 46, e.g., in excess of about 100 CFH, use of a restricting orifice 48 is optional.

In a representative embodiment, given a main flow path 46 having an area of about 0.4 in², and the low volume sampling path 47 having an area of 0.003 in², the orifice 48 can have a volume of about 0.2 in², i.e., about half of the main flow path 46.

In the arrangement shown in FIG. 3A, the sampling path 47 includes an inlet shunt line 50, which leads from the main gas passage 46 of the inlet line 32 (upstream of the orifice 48, if present). The inlet shunt line 50 communicates with an input of the resistance temperature device 40. The sampling path 47 also includes an outlet shunt line 52, which leads from the output of the resistance temperature device 40 into the main gas passage 46 of the inlet line 32 downstream of the inlet shunt line 50 (and downstream of the orifice 48, if present).

Alternatively, as shown in FIG. 3B, the outlet shunt line 52, which leads from the output of the resistance temperature device 40, does not return flow to the main gas passage 46. With adequate upstream pressure in the inlet shunt line 50, created, e.g., by the orifice 48, the outlet shunt line 52 can be vented to atmosphere or another appropriate location, as FIG. 3B shows.

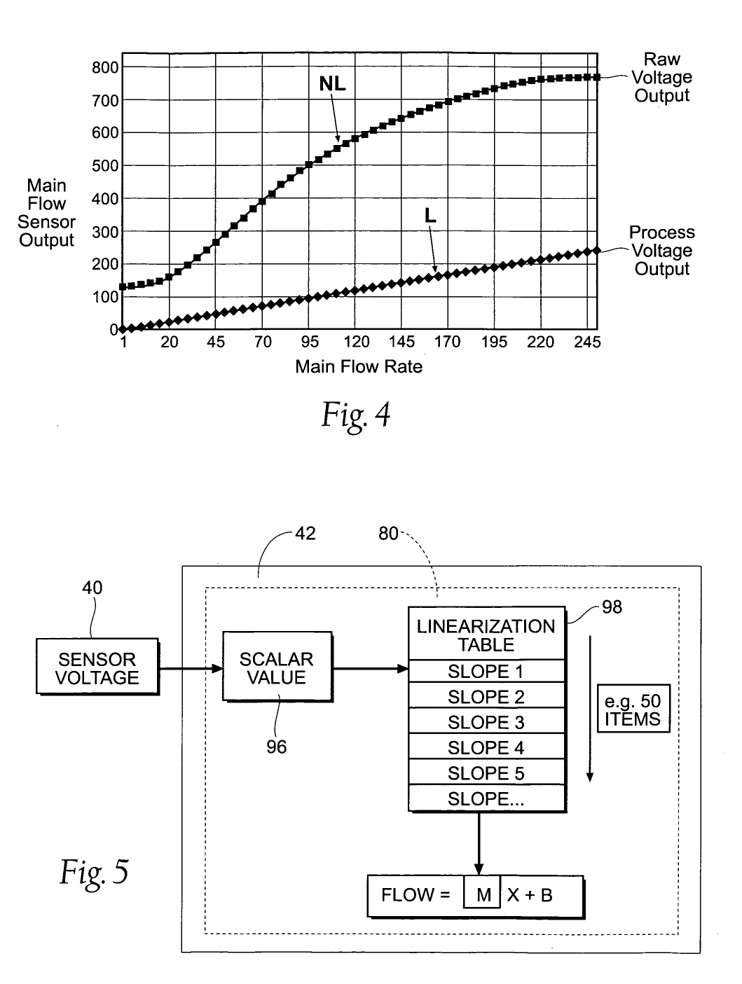

The small diameter shunt lines 50 and 52 (on the upstream and downstream sides of the flow restricting orifice 48, if present) direct a fraction of the total flow of gas in the main path 46 through the temperature resistance device 40 for measurement. Conventional thought believes that laminar flow is a prerequisite for using conventional mass flow sensors. According to conventional thought, a laminar flow is required so that the output of the mass flow sensor is linearly proportional to the total flow. As FIG. 4 shows, the raw voltage output of the temperature resistance device 40 (curve NL), which is indication of mass flow of the relatively small volume of gas conveyed through the sample measuring path 47, is not linearly related to the flow rate of the much larger volume of gas within the main path 46. That is because only a small fraction of gas flows through the sample measuring path 47 and because this small fraction is, like the larger flow in the main path 46, not laminar. Surprisingly, despite measuring only a small fraction of the volume of the total flow within the sample measuring path 47, and despite the presence of non-laminar flow conditions, it has been discovered that the fractional and non-linear flow of gas through the sample measuring path 47 is sufficient to make possible an accurate electronic correlation between the non-linear voltage output of a mass flow sensor in a sample measuring path 47 and a gas flow rate within the main path 46. The electronic correlation provides a virtual laminar flow representation of non-laminar main flow, so that the gas mass flow measured within the sample measurement path 47 can be related in a linear way to the gas flow rate within the main path 46.

More particularly, the flow rate measuring assembly 36 includes a conversion function 80 that resides within the processing device 42 (see FIG. 5). Due to the special configuration of the sampling path 47 (and its association with the flow restricting orifice 48, if present), the conversion function 80 is able to accurately convert the non-linear mass flow curve NL, into a linearized voltage-flow rate curve L, representative of the main flow, as FIG. 4 shows. The combination of the sampling path 47 (and the flow restricting orifice 48, if present) and the conversion function 80 emulates the functionality of a mass flow sensor operating in a low volume, laminar flow condition.

In the illustrated embodiment, the conversion function 80 (see FIG. 5) couples the raw mass flow output voltage from the temperature resistance device 40 to an analog-to-digital converter (ADC) 96. The ADC 96 converts the voltage to an integer count value, which in the illustrated embodiment lays the range of 0 to 4096 (the distribution of the count value with respect to flow rate defines the non-linear Curve NL in FIG. 4). The conversion function 80 converts the digital ADC count value to a scalar value, which is pointed to an element in a multiple item table 98. The table item defines the slope M in the linear equation for the flow rate (which defines the linear Curve L in FIG. 4):
Flow Rate=(M*X)+B
where X is the ADC count value, and
where B is a mathematically predetermined offset calculated by a “best fit” methodology.

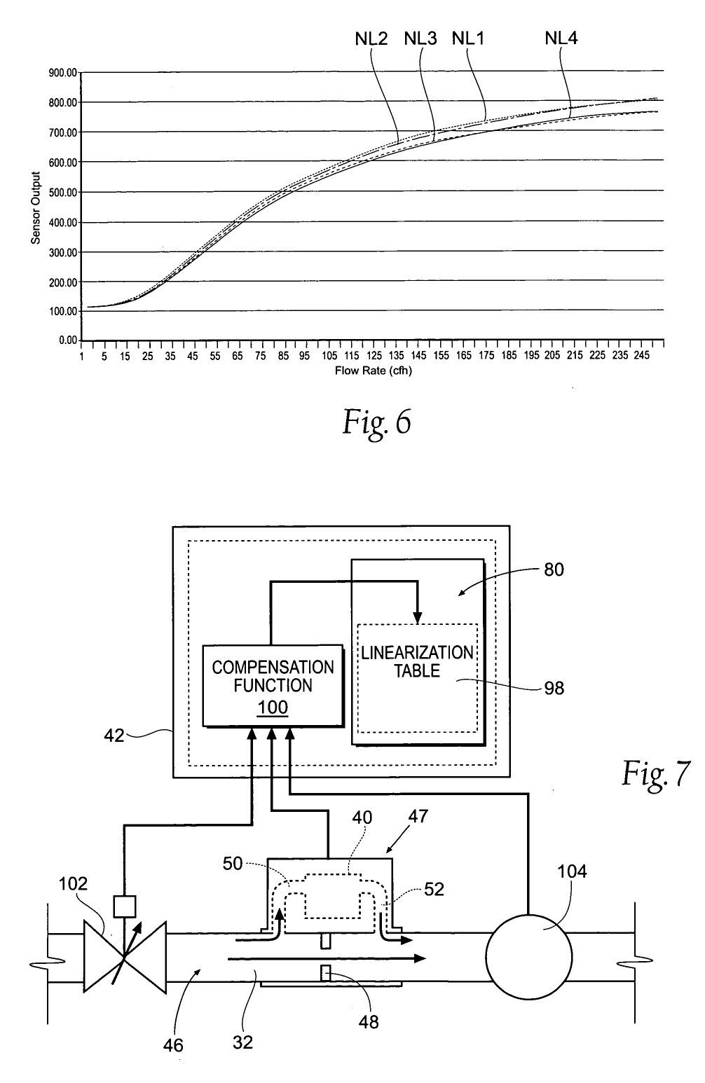

The table items for the linearization table 98 shown in FIG. 5 can be developed empirically for a particular temperature resistance device 40, taking into account the special configuration of the sampling path (and its association with the flow restricting orifice 48, if present), the expected specific gravity for the measured gas, as well as the expected units of measurement for the output. Still (as FIG. 6 shows), even among temperature resistance devices 40 of the same general family or type, the non-linear mass flow curves NL can vary (as the dissimilar non-linear curves NL1, NL2, NL3, and NL 4 in FIG. 6 indicate). The table items for the linearization table 98 can be developed to accommodate such differences in non-linear mass flow curves NL (shown in FIG. 6), to fit with reasonable accuracy with a single generic linearized voltage-flow rate construct or curve L, of the type shown in FIG. 4. In the arrangement, the conversion function 80 provides a generalized or generic linear conversion applicable with reasonable accuracy for a family or families of mass flow sensors expected to be used, as well as changes in the specific gravity for the measured gases, degradation of sensor performance over time, and changes in the units of measurement for the output.

In the embodiment shown in FIG. 7, the processing devices 42 of the flow rate measuring assembly 36 includes a compensation function 100. The compensation function 100 evaluates the raw non-linear output for the particular in-line mass flow sensor 40 in use over a range of actual flow values and develops for that mass flow sensor a custom-fitted linear conversion. The custom-fitted linear conversion is reflected in the elements of the linearization table 98 of the conversion function 80. The linear conversion in the table is now custom-fitted to the particular performance characteristic of that in-line mass flow sensor 40. The compensation function 100 in real time “teaches” or “trains” the conversion function 80 to assign a specific sensor output to a certain flow or process value, based upon sampling of actual performance characteristics of a particular flow sensor 40 then in use. The compensation function 100 obviates the loss of accuracy due to output variations among different sensors, or differences encountered in specific gravity for the measured gas, or differences due to degradation of performance over time, differences among units of measurement for the output for different types of mass flow sensors. The compensation function 100 customizes the processing device 42 for each flow sensor coupled to it, as well as to the particular processing conditions then present.

The compensation function 100 can operate in various ways. In the embodiment shown in FIG. 7, the compensation function 100 is coupled to an adjustable valve 100 placed in the main flow path 46 upstream of the mass flow meter (which, for the purpose of illustration, is the sensor configuration shown in FIG. 3A), the outout of which is also coupled to the compensation function 100. The compensation function 100 is also coupled to an independent gas flow rate measuring device 104 placed in the main flow path 46 downstream of the mass flow meter. In this arrangement, the compensation 100 operates in an initialization or “teaching” mode, to adjust the valve 102 in a range of prescribed increments to provide incremented mass flow values through the sensor 40 and corresponding incremented gas flow rate values through the independent measuring device 104. The compensation function 100 receives and registers the incremented outputs of the sensor 40 and the independent measurement device 104. By comparing the incremented values of the mass flow outputs of the sensor 40 to the likewise incremented values of the flow rate outputs of the independent measuring device 104, as affected by adjustment of the control valve 102, the compensation function 100 can assign the mass-flow output of the sensor 40 to the linearization table 98 correlated to flow rate output of the independent measuring device 104.

The compensation function 100 can also operate during the initialization or “teaching” mode based upon a manual selection of a process values (flows), and registering the corresponding sensor output when the desired process value (flow) is verified by other means. This registered value and the manually selected flow value is incorporated in the linearization table 98.

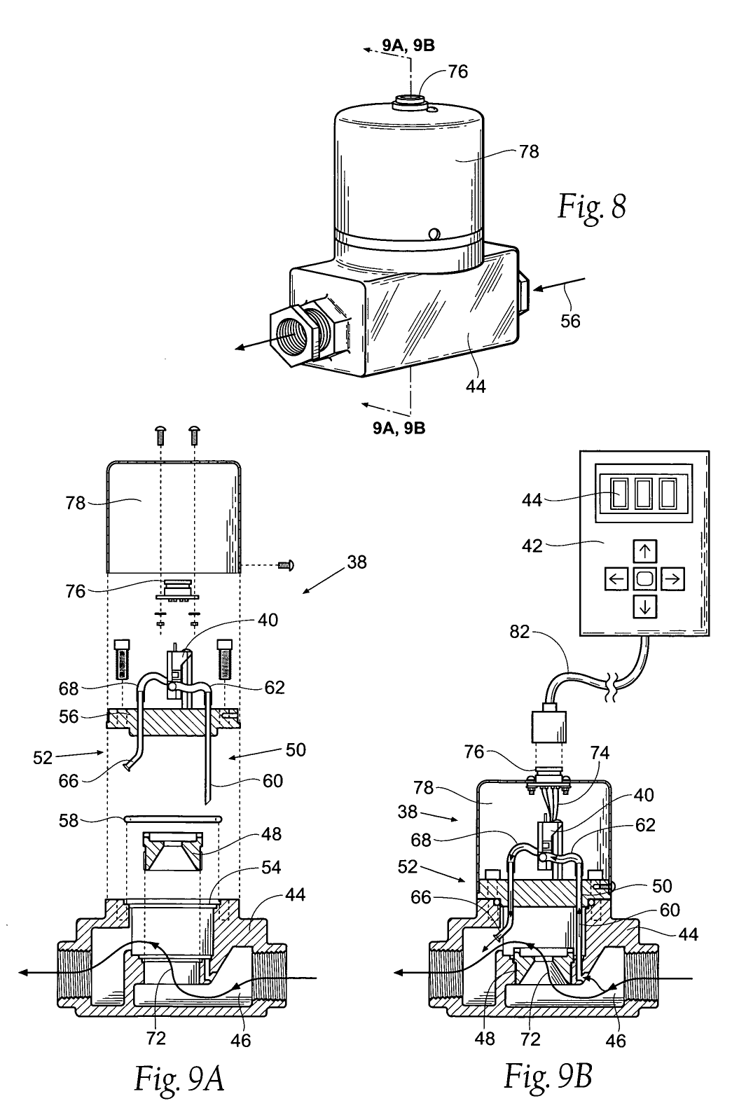

FIGS. 8 and 9A/9B show a representative physical embodiment of a mass flow meter 38 that embodies features of our invention.

In this arrangement, a steel housing defines the passage 46. The orifice 48 is fitted into the housing 46 through a formed access opening 54. A top plate 56 and o-ring 58 fit over and seal the access opening 54. In this arrangement, gas flow in the passage 46 proceeds from inlet to outlet in a dog-leg path through the orifice 48, as shown by arrow 72.

The temperature resistance device 40 (which, e.g., can comprise a Mass Airflow Sensor AWM3100V made by Honeywell) is mounted on the top plate 56. The device 40 is enclosed within a formed top cover 78.

In this embodiment, the inlet shunt line 50 comprises a rigid tube 60 and a hose 62, which can be made of a flexible material but need not be. The rigid tube 60 has an end that extends into the top cover 78 near the temperature resistance device 40. The rigid tube 60 has another end that extends through the top plate 56 and opens into the gas passage 46 upstream of the orifice 48. The hose 62 couples the near end to the inlet of the temperature resistance device within the cover 78.

In this embodiment, the outlet shunt line 52 comprises a rigid tube 66 and a hose 68, which can be made of a flexible material but need not be. The rigid tube 66 has an end that extends into the top cover 78 near the temperature resistance device 40. The rigid tube 66 has another end that extends through the top plate 56 and opens into the gas passage 46 downstream of the orifice 48. The hose 68 couples the near end 70 to the outlet of the temperature resistance device 40 within the cover 78.

Lead wires 74 electrically connect the output of the temperature resistance device 40 to a plug 76 carried by the cover 78. A cable 82 inserted into the plug 76 couples the output of the temperature resistance device 40 to the microprocessor 42 (see FIG. 9B).

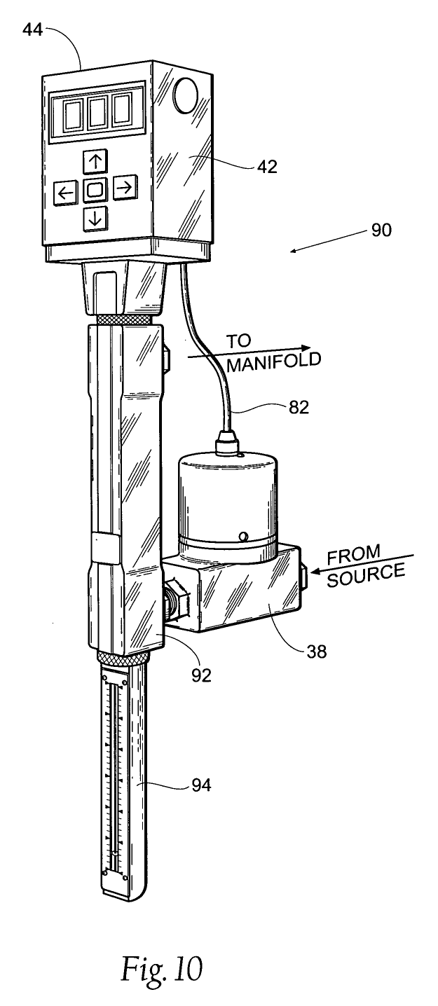

FIG. 10 shows a sensing assembly 90 comprising the mass flow sensor 38 as just described, coupled in close association with a conventional visual and/or non-electrically powered flow indicating/measuring device 92, which in the illustrated embodiment comprises a conventional rotometer 92. The rotometer 92 includes a conventional float assembly display 94 of flow rate of gas through the rotometer 92.

In the illustrated embodiment, the microprocessor 42 is also mounted to the assembly 90, so that the three components 38, 92, and 42 comprise an integrated unit. The microprocessor 42 can include an integrated display device 44, which displays the processed, linearized main flow rate based upon the measured sample of mass flow of gas through the mass flow sensor 38. It should be appreciated, however, that the microprocessor 42 and/or the display device 44 can be located remote from the joined assembly of the mass flow sensor 38 and the rotometer 92.

The assembly 90 combines traditional visual and/or non-electrically powered flow indication (i.e., the rotometer 92) with the output obtained by mass flow sensing (i.e., the mass flow sensor 38) in a convenient, compact package that can be easily handled and installed. Use of the mass flow sensor 38 provides the advanced benefits of digital mass flow technology. The flow rate information shown on a digital display 44 is immune to possible error from gas pressure and gas temperature variations. However, the presence of the rotometer 92 provides familiar visual and/or non-electrically powered flow indication and the benefits of well-known analog flow sensing technology. The assembly 90 provides the best of analog and digital worlds in a compact, convenient package.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A gas flow rate measuring device for use in association with a heat treating system including a heat treating furnace and supply apparatus to supply a gas atmosphere to the heat treating furnace, the device comprising a flow rate measuring assembly associated with the supply apparatus that derives a gas flow rate in the supply apparatus based, at least in part, upon measuring mass gas flow in the supply apparatus.

2. A method of heat treating using the device defined in claim 1.

3. A device according to claim 1 used in conjunction with a visual flow indicating/measuring device.

4. A device according to claim 1 used in conjunction with a non-electronic flow indicating/measuring device.

5. A gas flow rate measuring device including a sampling path communicating with a main gas flow path, a mass flow sensor in the sampling path generating a non-linear mass flow output based upon sensed gas flow in the sampling path, and a processing component coupled to the mass flow sensor, the processing component including a conversion function that converts the non-linear mass flow output to a linearized voltage-flow rate output representative of gas flow rate in the main gas flow path.

6. A device according to claim 5 used in conjunction with a visual flow indicating/measuring device representative of gas flow in the main gas flow path.

7. A device according to claim 5 used in conjunction with a non-electronic flow indicating/measuring device representative of gas flow in the man gas flow path.

8. A device according to claim 5 wherein the conversion function includes a linear correlation between non-linear mass flow outputs and gas flow rates.

9. A device according to claim 8 wherein the processing component includes a comparison function that generates the linear correlation for the conversion function.

10. A device according to claim 8 wherein the processing component includes a comparison function that generates the linear correlation for the conversion function based, at least in part, upon sensed actual gas flow conditions in the main gas flow path.

11. A method of monitoring gas flow in a main gas flow path comprising sampling the gas flow with a mass flow sensor, generating a mass-flow sensor output based upon the sampling, and deriving a gas flow rate based, at least in part, upon the mass-flow sensor output.

12. A method according to claim 11 wherein the mass-flow sensor output is not linear, and wherein the deriving converts of the non-linear mass-flow sensor output to a linearized voltage-flow rate output representative of gas flow rate in the main gas flow path.

13. A processing device including an input for receiving a non-linear output from a mass flow sensor sampling gas flow in a flow path, a comparison function that converts the non-linear mass flow output to a linearized voltage-flow rate output representative of a gas flow rate in the flow path, and an output for the linearized voltage-flow rate output.

14. A processing device according to claim 13 wherein the comparison function includes a linear correlation between non-linear mass flow outputs and gas flow rates.

15. A processing device according to claim 14 further including a comparison function that generates the linear correlation for the conversion function.

16. A processing device according to claim 14 further including a comparison function that generates the linear correlation for the conversion function based, at least in part, upon actual gas flow conditions in the flow path.
